(19) United States
(12) Patent Application Publication
(10) Pub. No.: US 2014/0157664 A1
(43) Pub. Date: Jun. 12, 2014

(54) Watering Device for Plant Irrigation

(71) Applicant: LYNDA MAE BRAUN, COURTENAY (CA)

(72) Inventor: LYNDA MAE BRAUN, COURTENAY (CA)

(21) Appl. No.: 13/712,603

(22) Filed: Dec. 12, 2012

(51) Int. Cl. A01G 27/00

(52) U.S. Cl. CPC A01G 27/00
USPC 47/48.5; 29/428; 29/460

(57) ABSTRACT

A plant watering device comprises a pair of water absorbent shells made from natural coconut husks. Cotton pads are placed between the shells for further water storage and slow persistent release. An amount of plant nutrient, colloidal silver and water filtering carbon material is placed within the cotton pads for disbursement to the root system of a plant. The husks and cotton pads are stacked. The two husks are then sewn together. The device is buried in a planter in close proximity to a root system of a plant.

### CROSS-REFERENCE TO OTHER APPLICATIONS

This application is related to my issued patent # U.S. Pat. No. 8,122,641 “Watering device for plant irrigation”.

### FIELD OF THE INVENTION

This invention relates to the field of plant irrigation devices and more particularly to an improved watering device for plant irrigation incorporating liquid silver colloidal as an anti-bacterial agent.

### BACKGROUND OF THE INVENTION

Household plants. particularly those that are kept indoors, are susceptible to de-hydration. They must be watered at frequent intervals. Low humidity indoor environments promote the de-hydration of plants and the soil they are rooted in. Plant death by de-hydration can occur quickly if the care-taker is not attentive. This creates additional costs for the care-taker in having to replace dead plants unnecessarily.

There are a number of devices available to keep plants hydrated. In one example of prior art, vermiculite or similar absorbent is mixed in with soil to maintain an acceptable soil moisture content. However, the vermiculite must be mixed in the soil and this creates additional work and can be messy. Another sample of the prior art is shown in U.S. patent application Ser. No. 2004/0025428 “Watering Device” by De Winter. This apparatus comprises a reservoir of water and a soil probe through which the water is fed to the soil. This apparatus is made of molded plastic and has plastic parts in the soil and above the soil. This makes this device obtrusive and unnatural. The need to fabricate molded parts from a suitable thermoplastic material makes this device less than environmentally benign.

Therefore there is a need to be able to inexpensively and naturally hydrate the root systems of plants. It would also be beneficial to hydrate and provide a nutrient to the plant at the same time. I have also found it beneficial and novel to incorporate liquid silver colloidal as a bactericide.

### SUMMARY OF THE INVENTION

To overcome the deficiencies of the prior art. I have provided a plant watering device. My device comprises a first outside absorbing shell, a second outside absorbing shell and a suitable amount of absorbing material sandwiched between the two outside absorbing shells. The two outside absorbing shells are sewn together. They act as a water reservoir to slowly release water back to the surrounding soil and to the adjacent plant roots. The two outside shells are wrapped in a mesh material. The absorbing material sandwiched between the two shells includes a predetermined amount of a nutrient for feeding plant roots. As well, the improvement to my invention is the addition of liquid silver colloidal to the absorbing material to act as a bactericide. An amount of filter medium for cleansing absorbed water is also placed in the absorbing material. The shells are made from natural coconut husk fibers and the absorbing material is a natural cotton bat.

### DESCRIPTION OF THE DRAWINGS

FIG. 1 is a top view of one embodiment of the invention.

FIG. 2 is a side view of one embodiment of the invention.

FIG. 3 is a cross-sectional side view of one embodiment of the invention.

FIG. 4 is a view of the components of one embodiment of the invention prior to assembly.

FIG. 5 is an assembly view of one embodiment of the invention.

FIG. 6 is a top view of a partially assembled invention prior to sewing.

FIG. 7 is a cross-sectional side view of a partially assembled invention prior to sewing.

FIG. 8 illustrates use of the invention in a plant pot.

### DESCRIPTION OF THE INVENTION

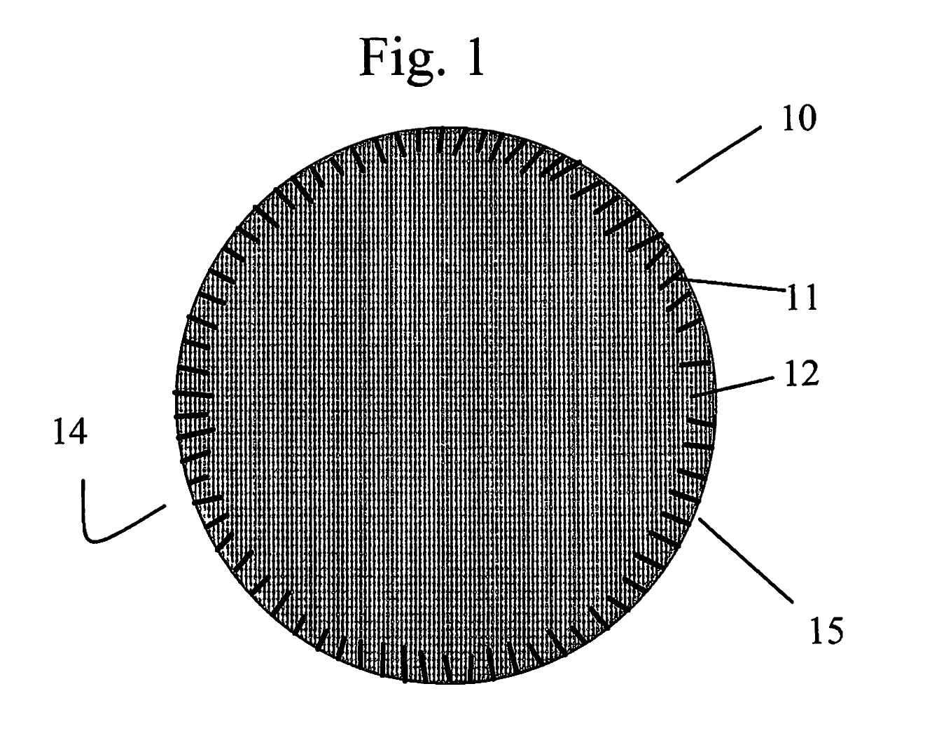

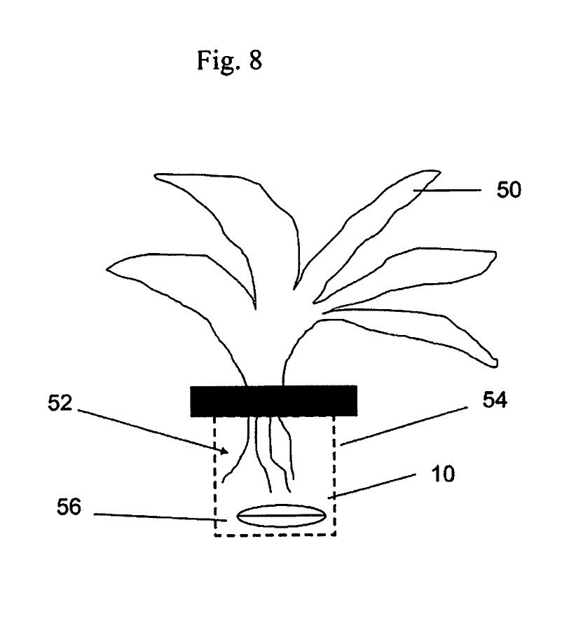

Referring to FIG. 1 there is shown one embodiment of my improved invention 10 which is a watering device for plant irrigation. The watering device 10 comprises a water absorbent top shell 12 and a water absorbent bottom shell 14 disposed beneath the top shell. Sandwiched between the top 12 and bottom 14 shells is an absorbent layer 15 suitable for carrying a plant nutrient and a water filtration medium. A bactericide is also included within the absorbent layer 15. The bactericide is colloidal silver in a preferred embodiment. The top shell 12 and the bottom shell 14 are sewn together with a suitable thread 11. The stitching pattern may vary. The water absorbent shells permit water to enter the device when charging it and to leave the device when it is discharging water into plant soil adjacent to the root structure of a plant (see FIG. 8).

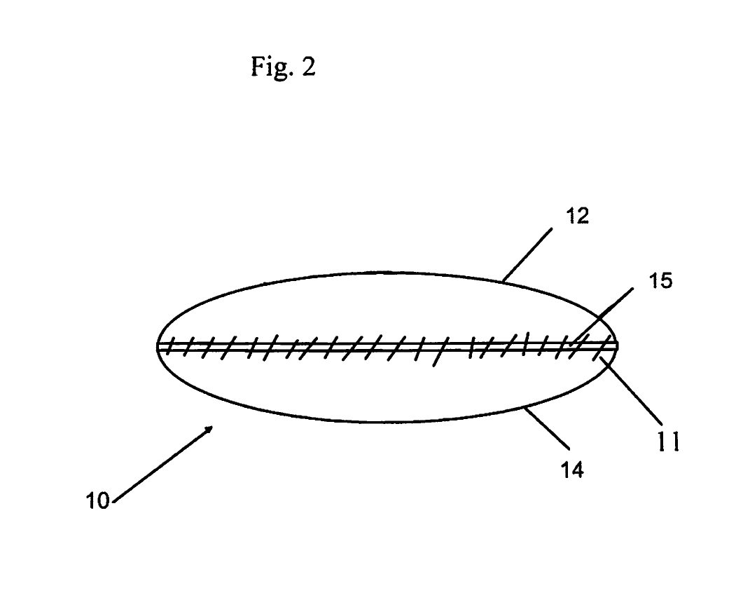

Referring to FIG. 2 there is shown a diagram of the improved invention 10 in side view. The top shell 12 and the bottom shell 14 comprise natural and organic absorbent material that has an inherent resistance to decay in moist and poorly oxygenated environments. In the preferred embodiment that material is coconut husk which is inexpensive and readily available. The coconut husk material is readily formed into top 12 and bottom 14 shells. These top and bottom shells are sewn together with a suitable thread 11. Between the top 12 and bottom 14 shells is an absorbent layer 15 for holding time release fertilizers and nutrients as well as water filtration media. Colloidal silver is included as a bactericide.

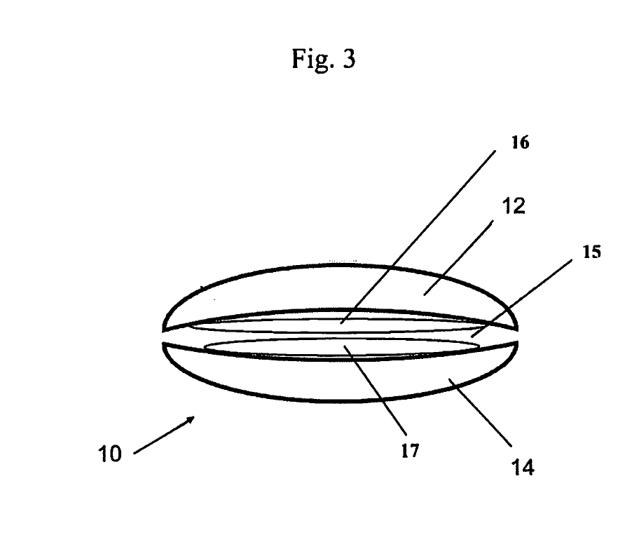

Referring to FIG. 3 there is illustrated a cross-sectional side view of components of an assembled sample of the invention 10 comprising a top shell 12. a bottom shell 14 and an absorbent layer 15. The absorbent layer 15 comprises a top cotton pad 16 and a bottom cotton pad 17. Not shown is a centrally disposed cotton washer 19 the annulus 21 of which contains the nutrient material, silver colloidal and water filter media. The top and bottom shells are sewn together.

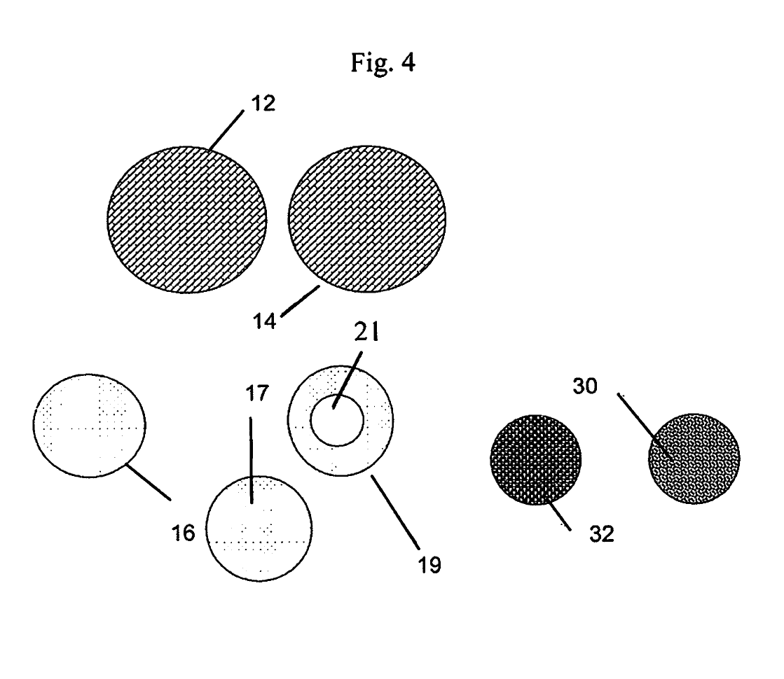

Referring now to FIG. 4 there is shown in top view the constituent parts of the invention. The top 12 and bottom 14 shells are made from coconut husks which are known for their water absorbent characteristics, resistance to rot and longevity. As well, the husks are a purely natural and organic material and their use underscores the environmentally benign nature of my invention. The top and bottom shells are sewn together around their adjacent peripheral edges. Elements 16, 17 and 19 are made from a suitable absorbent material. In a preferred embodiment 16 and 17 are natural cotton fiber pads. Element 19 is a cotton pad with a centre portion removed to form an annulus 21 in which the nutrient, silver colloidal and filter material are placed. The absorbent nature of the cotton acts to store water in all three cotton elements. The nutrient material is dissolved within the annulus 21 and leaches its way through the husk into the surrounding soil where it is absorbed by the plant roots. The silver colloidal will act as a bactericide to ensure healthy roots. The cotton fiber can be purchased as cotton wafers or as bats. The nutrient 30 can be any suitable water soluble slow-release fertilizing agent. The filter medium 32 is charcoal and is used to cleanse the water as it is released to the plant.

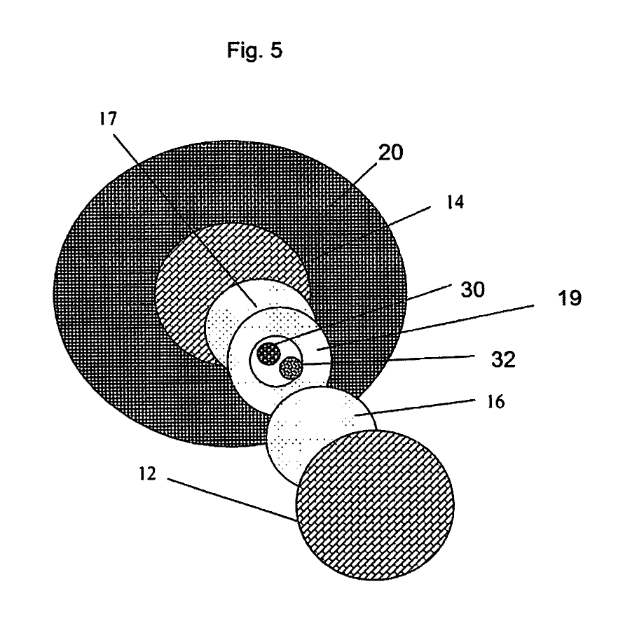

Referring to FIG. 5. there is shown an assembly diagram of one embodiment of the invention. The dimensions of the items shown depend on the size of the device being assembled. The bottom shell 14 is placed on a flat surface 20. A first cotton pad 17 is placed in the centre of the bottom shell 14. The cotton washer 19 is placed over the first cotton pad 17. Nutrient material 30. silver colloidal and charcoal filter media 32 are placed within the center of the cotton washer.

A second cotton pad 16 is placed over the nutrient material and charcoal. The top shell 12 is placed upon the second cotton pad 16.

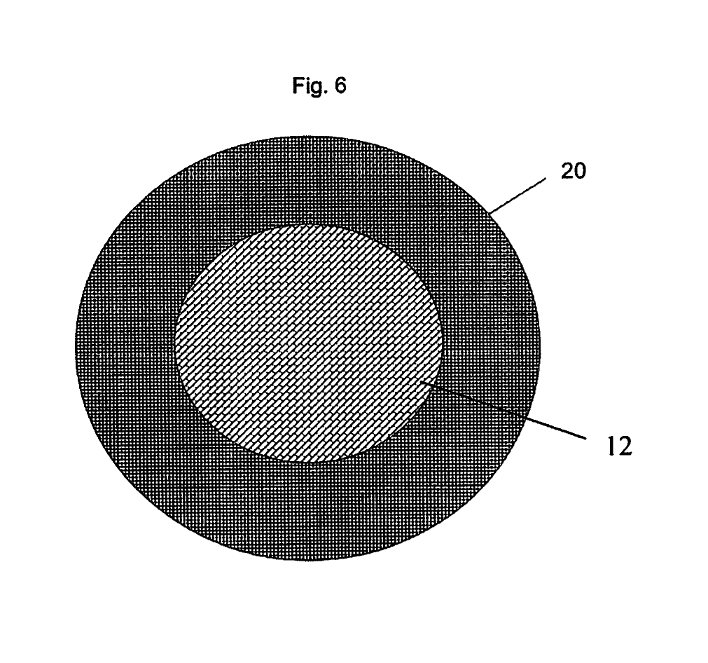

Referring to FIG. 6 prior to final assembly of the device, the top shell 12. with the other constituent parts stacked below it on a flat surface 20 prior to sewing the two shells together around their adjacent edges.

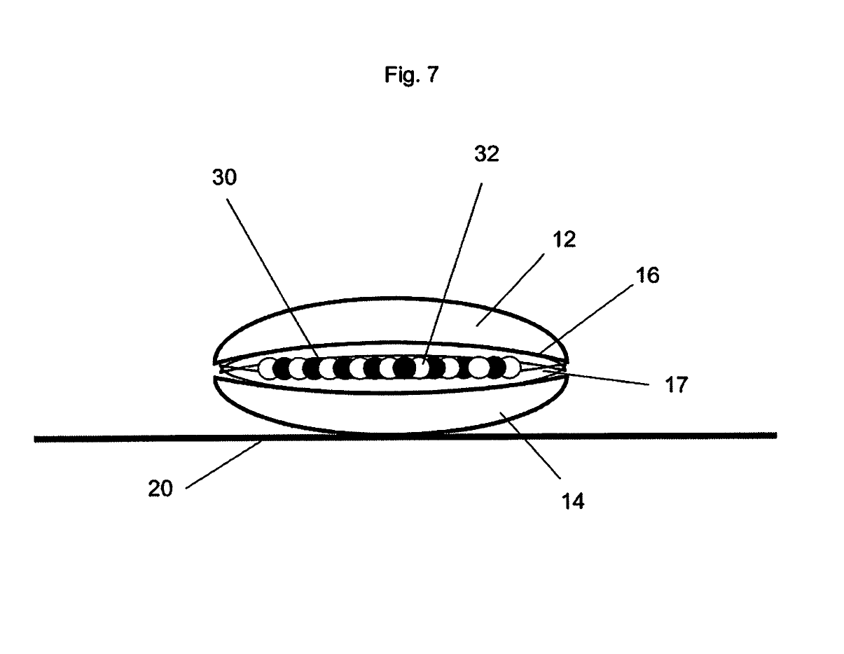

FIG. 7 illustrates a partially assembled device in cross-section. The top 12 and bottom 14 coconut shells are disposed upon flat surface 20 awaiting sewing. The gap between the top and bottom shells is exaggerated to show the interior elements. Placed between the shells are cotton fiber pads 16 and 17. Between them is cotton washer pad 19 (although it is not illustrated to avoid clutter in the diagram). The nutrient material 30 is illustrated as a black dot and the filter media 32 is illustrated as a white dot. Colloidal silver is absorbed into the cotton washer pad. It is to be understood that these two materials are well mixed within the device.

Referring to FIG. 8. there is illustrated a plant 50 within a pot 54 shown in cross-section. The plant root structure 52 is buried in potting soil 56. The device 10 is first soaked in water and buried below the plant root structure 52 so that water and nutrients can disburse into the soil close to the roots. Preferably the device is near the bottom of the pot prior to planting the plant. This will keep the plant well hydrated and fed.

Although the description above contains much specificity, these should not be construed as limiting the scope of the invention but as merely providing illustrations of some of the presently preferred embodiments of this invention. Thus the scope of the invention should be determined by the appended claims and their legal equivalents.

What is claimed is:

1. A plant watering device comprising a top water absorbing shell, a bottom water absorbing shell, a layer of water absorbing material disposed in a stacked configuration between said top and said bottom shells, wherein the top and the bottom shells are sewn together around their peripheral edges using a suitable thread.

2. The device of claim I wherein said layer of water absorbing material comprises a top absorbing pad disposed beneath the top shell, a bottom absorbing pad disposed above the bottom shell and a central absorbing pad disposed between said bottom and said top absorbing pads.

3. The device of claim 2 wherein said central absorbing pad includes a centrally disposed annulus.

4. The device of claim 3 wherein a first predetermined amount of a nutrient for feeding plant roots is placed within said centrally disposed annulus.

5. The device of claim 4 wherein a second predetermined amount of filter medium for cleansing absorbed water is placed within the centrally disposed annulus.

6. The device of claim 5 wherein a third predetermined amount of anti-bacterial agent is placed within the centrally disposed annulus.

7. The device of claim 5 wherein said third predetermined amount of anti-bacterial agent is colloidal silver.

8. The device of claim 1 wherein the first absorbing shell and the second absorbing shell are made from natural coconut husk fibers.

9. The device of claim 1 wherein the layer of water absorbing material is made from natural cotton fiber.

10. The water device as claimed in claim 5 wherein said filter medium is charcoal.

11. A method of assembling a plant watering device comprising the steps of:
a. Taking a first coconut husk absorbing shell and placing it on a flat surface;
b. Placing a first cotton fiber pad on the surface of the first coconut husk;
c. Placing a first cotton fiber washer having an annulus on the surface of said first cotton fiber pad;
d. Placing a suitable first amount of nutrient material within said annulus;
e. Placing a suitable second amount of filter material within the annulus;
f. Placing a third suitable amount of anti-bacterial agent within the annulus;
g. Placing a second cotton fiber pad on the surface of said first cotton fiber washer;
h. Placing a second coconut husk absorbing shell over said second cotton fiber pad;
i. Sewing the first coconut husk and the second coconut husk together around their peripheral edges using a suitable thread; and,
j. Affixing a brand label to the secured stacked material.

12. The method of claim 11 wherein said third suitable amount of anti-bacterial agent is colloidal silver.

13. The method of claim 11 further including the step of soaking the assembled device in water.

14. The method of claim 13. further including the step of placing the soaked device in proximity to a plant root system.
